(19) United States
(12) Patent Application Publication
(10) Pub. No.: US 2011/0111208 A1
(43) Pub. Date: May 12, 2011

(54) USE OF AN ENCAPSULATED ADHESION PROMOTER IN AN AQUEOUS ADHESIVE JOINT BONDING TWO SUBSTRATES, AT LEAST ONE OF WHICH COMPRISES A (TPE-PA) MATERIAL

(75) Inventors: Bruno D'Herbecourt, Bernay (FR); Rene-Paul Eustache, Combon (FR)

(73) Assignee: Arkema France, Colombes (FR)

(21) Appl. No.: 13/054,216

(22) PCT Filed: Jul. 1, 2009
(86) PCT No.: PCT/FR2009/051275

§ 371 Date: Jan. 14, 2011

(30) Foreign Application Priority Data
Jul. 16, 2008 (FR) 0854833

(51) Int. Cl. B32B 5/16; B32B 37/02; B32B 37/06; B32B 37/10; B32B 37/12; B32B 37/14; B32B 27/00

(52) U.S. Cl. 428/323; 156/281; 428/402.2

(57) ABSTRACT

“The present invention relates to the use of an encapsulated adhesion promoter in an effective amount in an aqueous adhesive joint, said aqueous adhesive joint being intended to bond a surface of a first substrate (S1) to a surface of a second substrate (S2), at least one of said two substrates comprising a material (TPE-PA) comprising at least one thermoplastic elastomer (TPE) and/or at least one polyamide (PA), said adhesion promoter (P) comprising at least one organic molecule having at least one isocyanate function blocked by encapsulation of said organic molecule.”

### FIELD OF THE INVENTION

The present invention relates to assembly, by bonding, of a first substrate S1 based on a thermoplastic elastomer (abbreviated to TPE) and/or a homopolymeric or copolymeric polyamide (PA), and a second substrate S2, the substrates S1 and S2 possibly being of the same nature or of a different nature.

These various possibilities for the composition of the substrate S1 and possibly for the substrate S2 if it is of the same nature will hereinafter be denoted (TPE-PA). In addition, the term “(TPE-PA) substrate” means a substrate that comprises at least one TPE elastomer or at least one PA, or again a mixture of at least one TPE and at least one PA.

The present invention also relates to a laminated product formed by assembling such substrates S1 and S2 by means of an aqueous adhesive joint.

The term “aqueous adhesive joint” means a joint wherein the compositions of primers and/or aqueous adhesives used in successive layers on the (TPE-PA) substrates comprise less than 5% of organic solvents.

The present invention also relates to a method for manufacturing such a laminate and to its use in the footwear industry, especially for the manufacture of soles and in particular for the soles of sports footwear.

One of the principal skills of the footwear industry resides in its great expertise regarding bonding techniques for assembling materials with different chemical natures and mechanical properties. This skill is particularly important in the field of sports footwear where the materials used, especially for the manufacture of soles, are frequently novel materials. This demand is multiplied by the need for the performance generally linked to sports footwear.

During the last decade, materials based on TPE-PA, such as materials sold by the supplier Arkema under the trade name Pebax® and Rilsan®, have become more and more popular in the high end footwear field, in particular for sports footwear, because of their mechanical properties and in particular their exceptional resilience properties.

Substrates formed from such polyamide block polyether copolymers, especially for the manufacture of soles for sports footwear, are generally assembled by bonding to other substrates using an adhesive joint.

In general, bonding such a substrate type to produce a laminate necessitates at least the following operations:
cleaning the surfaces of the substrates to be bonded, for example with an organic solvent such as methylethylketone (MEK) or with an aqueous based detergent solution;
applying a layer of adhesive joint, either in a solvent or in aqueous solution, to at least the contacting surface of the TPE-PA substrate (S1), generally using a brush; this may optionally include application of a primer, generally in a solvent;
bringing the two substrates into contact; and
pressing the assembly resulting from contacting.

During this bonding, both prior art primer and adhesive compositions lead to evaporation of a large quantity of organic solvent. Thus, when manufacturing a laminate for footwear, it is estimated that the average quantity of adhesive used per item of footwear is 5 g and that of the primer composition is 3 g; the solvent emission can be determined to be 2.9 g per item of footwear. Assuming a production of 10 000 items of footwear per day for a production unit, the total quantity of solvent given off by that unit is 29 kg per day.

Using an aqueous based adhesive joint can alleviate this disadvantage. Unfortunately, the degrees of adhesion and the quality of the bond, expressed as the peeling force for substrates based on TPE-PA, is far from being optimal for prior art laminates. Thus, with substrates formed from polyamide block polyether copolymer with a mean hardness of 55 to 70 Shore D (for example Pebax® 55-1, Pebax® 70-1), low peeling forces in the range from approximately 0.5 kg/cm to 3 kg/cm are obtained. However, footwear manufacturers require a peeling strength of more than 3 kg/cm. In general, aqueous adhesive joints bond with great difficulty, and in the majority of cases do not bond at all on TPE substrates, as they have little or no compatibility with them.

One of the rare aqueous based adhesives that can be used to bond onto TPE-PA substrates comprises hydrodispersible aliphatic polyisocyanates, in the form of emulsions. Examples that may be cited are hexamethylene diisocyanate, abbreviated to HDI, for example the products sold under the trade name Desmodur® DN by the supplier Bayer. Because of their low reactivity, said polyisocyanates cannot by themselves produce acceptable degrees of adhesion (i.e. a peeling strength of more than 3 kg/cm) on TPE supports.

Attempts have been made to improve adhesion on (TPE-PA) substrates by incorporating polymers such as silanes into the primer or adhesive formulations or by means of surface treatment techniques such as flame treatment, treatment with ultraviolet, corona discharge treatment, plasma treatment, or electron beam treatment.

Other techniques include chemical treatments such as, for example, attacking the substrates to be bonded using acid or basic solutions, or using specific solvents for the materials. By way of example, metacresol is a particularly suitable solvent for polyamide based polymers. A surface treatment with metacresol modifies the surface of the polyamide substrates and means that the aliphatic isocyanates can adhere more easily to this PA surface. However, that type of solvent (metacresol) is highly toxic. Furthermore, that treatment can only be used in the case in which two PA substrates have to be bonded together, as metacresol does not act on other types of substrates.

Those acid or basic solutions or those solvents are difficult to handle because of their toxicity, their ecotoxicity and/or their corrosive nature. Thus, their use is frequently limited and demands suitable protective, application and waste treatment equipment. A number of complementary steps are frequently necessary, such as neutralization of the chemical treatments, rinsing and drying. All of those steps give rise to waste, which generates pollution. Those additional steps of the assembly procedure consume energy and reduce productivity, especially when assembly is carried out on production lines.

Furthermore, when those surface treatments are complete, the substrate surface, the solidity and the mechanical properties of those substrates have been modified.

High reactivity polyisocyanates exist; they are generally aromatic, but as they are, they cannot be dispersed in water as they are incompatible with water, insoluble and sensitive to water.

Latent adhesives exist comprising such high reactivity isocyanate groups, but they are deactivated by an aliphatic amine to avoid such incompatibility problems. Such latent adhesives may be in the form of aqueous dispersions of solid particles. The aliphatic amines react with the isocyanate groups at the surface of such solid particles, thereby creating urea groups. Such a dispersion of particles with deactivated, and therefore non-reactive, isocyanate groups can be mixed with a dispersion of molecules having polyurethane groups without risking cross-linking, and thus form a “monocomponent” adhesive composition. The term “latent adhesive” is used for an adhesive that initially is applied to a substrate and then is dried in order to evaporate all the water from the adhesive, generally at low temperature in order to prevent the isocyanate functions from becoming reactive. In this manner, the surface of such a pre-bonded substrate is non-tacky, meaning that the substrate can be handled and stored easily. At another time (generally much later following storage, transport and/or dimensioning of the pre-bonded substrate), the parts comprising the pre-bonded substrate are assembled by simultaneous pressing and heat activation. During assembly by pressing, the substrates are heated to a sufficient temperature (of the order of 60° C. to 90° C.) in order to allow the encapsulated polyisocyanates to become reactive. A second step for cooling the laminate formed by the bonded substrates is then necessary.

Such a procedure for pre-bonding then hot bonding is generally employed by the automobile or furniture industry. That procedure then consists of continuously applying a generally monocomponent adhesive (polyurethane and isocyanate groups in the same composition) to a substrate using a roller.

The adhesive is then dried to evaporate off the water, but not activated so that the polyurethane and isocyanate groups do not cross-link together. If drying has not been carried out in advance during activation, when it comes into direct contact with the isocyanates, the water prevents or perturbs the normal cross-linking reaction of the isocyanates with the polyurethanes. The isocyanate molecules cross-link between themselves (auto-cross-linking) to form a precipitate in the aqueous medium.

The substrates are then stored, for example on coils. Generally, these coils are then cut as a function of the geometry of the parts to be bonded. The parts are brought into contact with another substrate under pressure while simultaneously increasing the temperature to activate the adhesive (i.e. to cure it) and bond the two substrates.

In this type of bonding, the parts must be able to withstand both a high pressure and a high temperature to avoid the risk of being damaged, deteriorated or deformed; further, their mechanical properties must not be modified.

Furthermore, such a two-step bonding process (pre-bonding then bonding) is not suitable for bonding laminates manufactured in the footwear field. In particular, the latent bonding process described above cannot be applied to laminates formed by materials that are both thicker and more sensitive to heat. The parts are generally complex shapes (molded parts) and necessitate rapid, successive bonds, which already involve a large number of steps on a production line. Furthermore, the shape of the part and the materials of which it is composed means that it is not always possible to heat the whole of the part, especially during pressing.

Thus, the present invention aims to improve the adhesion of materials based on TPE-PA to aqueous adhesive joints. In particular, the invention proposes the provision of an aqueous based adhesive composition that is ready-to-use, which can bond TPE-PA substrates to any other type of substrate, in order to manufacture a laminate with an improved degree of adhesion, with a peeling resistance of more than 3 kg/cm at least.

The present invention also aims to provide a method for manufacturing such a laminate that is simple and easy to implement, which suffers from none of the disadvantages of the prior art, and in particular avoids a major release of solvent, which has as few steps as possible in order to reduce the assembly time, and which does not deleteriously modify the mechanical properties of the substrate.

The present invention also pertains to increasing the adhesion of TPE-PA materials with aqueous adhesive joints, thereby avoiding the use of primers and/or adhesives based on solvents.

The Applicant has surprisingly demonstrated that the use, in an aqueous adhesive joint, of aqueous dispersions of molecules having encapsulated high reactivity isocyanate functions, allows instantaneous bonding of substrates based on TPE-PA materials, and even increases the adhesion of said substrates with other types of substrate.

### SUMMARY OF THE INVENTION

Thus, the present invention pertains to the use of an encapsulated adhesion promoter (P) in an effective quantity in an aqueous adhesive joint, said aqueous adhesive joint being intended to bond a surface of a first substrate (S1) to a surface of a second substrate (S2), at least one (S1) of said two substrates comprising a material (TPE-PA) comprising at least one thermoplastic elastomer (TPE) and/or at least one polyamide (PA), said adhesion promoter (P) comprising at least one organic molecule comprising at least two isocyanate functions blocked by encapsulation of said organic molecule.

Advantageously, said aqueous adhesive joint comprises at least one layer of aqueous primer and/or at least one layer of aqueous adhesive, said encapsulated adhesion promoter (P) being used in said aqueous primer and/or said aqueous adhesive such that the quantity of adhesion promoter (P) represents 0.5% to 20% by weight of active substance, preferably 0.5% to 10% by weight of active substance, with respect to the total adhesive joint weight.

Advantageously, said adhesive and/or said primer are in the bicomponent form:
a first component comprising a functionalized or non-functionalized resin, in solution or in dispersion in water, and reactive with the isocyanate functions;
a second component comprising a cross-linking agent in solution or in dispersion in water, said cross-linking agent comprising at least one molecule having blocked or non-blocked aliphatic isocyanate group(s) and/or at least said encapsulated adhesion promoter (P).

Advantageously, said first component and said second component are included in a ready-to-use monocomponent adhesive and/or primer composition.

Advantageously, said encapsulated adhesion promoter (P) comprises at least one of the following aromatic organic molecules having isocyanate groups: 4,4′-methylene di(phenylisocyanate) (MDI), isophorone diisocyanate (IPDI), toluylene diisocyanate (TDI), toluylene diisocyanate-uretdione (TDI-U), TDI-urea, naphthalene-1,5-diisocyanate (NDI), 3,3′-dimethyl biphenyl-4,4′-diisocyanate (TODI) and IPDI isocyanurate (IPDI-T), and mixtures thereof.

Advantageously, said encapsulated adhesion promoter comprises at least one TDI type and/or IPDI type aromatic isocyanate.

Advantageously, said encapsulation is carried out using at least one encapsulating agent selected from aliphatic amines and mixtures thereof.

Advantageously, said at least one encapsulating agent is selected from: 2-pentamethylene-1,5-diamine and its isomers and homologs. The term “homologs” means molecules (alkanes, alkenes, etc.) having amine functions, and with a similar chemical structure, containing substantially the same number of carbon atoms to within 1, 2 or 3 carbon atoms. Preferably, said homologs are 1,6-hexamethylene diamine, di-sec-butylamine; ethylene diamine; 1,3-propylene diamine; diethylene triamine; triethylene tetramine; 3,3′-dimethyl-4,4′-diaminodicyclohexylmethane; methylnonane diamine; isophorone diamine; 4,4′-diaminodicyclohexylmethane; or an alkanol amine or diamine such as ethanolamine or diethanolamine; and mixtures thereof.

Advantageously, said at least one TPE is selected from COPEs and/or TPUs and/or PEBAs and/or mixtures thereof.

Advantageously, the material of substrate S1 and the material of substrate S2 have the same chemical nature, i.e. substrate S1, like substrate S2, are based on the material TPE-PA. In this case, S2, like S1, comprises at least one thermoplastic elastomer (TPE) or at least one polyamide (PA) or a mixture of TPE and PA.

Advantageously, the material of substrate S1 and the material of substrate S2 have different natures, S2 being selected from TPEs, homopolymers and copolymers such as polyolefins; polyamines; polyamides; polyesters; polyethers; polyesterethers; polyimides; polycarbonates; phenolic resins; polyurethanes, cross-linked or not cross-linked, especially in the form of a foam; poly(ethylene-vinyl acetate); natural or synthetic elastomers such as polybutadienes, polyisoprenes, styrene-butadiene-styrenes (SBS), styrene-butadiene-acrylonitriles (SBN), polyacrylonitriles; natural or synthetic fabrics, especially fabrics formed from organic polymer fibers, such as fabrics formed from polypropylene, polyethylene, polyesters, polyvinyl alcohol, polyvinyl acetate, polyvinyl chloride or polyamide fibers; fabrics formed from glass fibers or carbon fibers, as well as materials such as leather, paper or card; and mixtures thereof.

The present invention also pertains to a method for assembling two substrates S1 and S2 by bonding by means of an aqueous adhesive joint, at least one of said substrates being formed from (TPE-PA) material comprising at least one thermoplastic elastomer, TPE, and/or at least one polyamide, PA, said method comprising the following order of steps:

(a) cleaning the surface of the (TPE-PA) substrate or substrates with a cleaning solution;

(b) applying an aqueous adhesive joint comprising an adhesion promoter as hereinbefore defined to said surface of at least one of the two substrates;

(c) curing the adhesive joint at a temperature in the range 60° C. to 150° C.;

(d) bringing said surface comprising the aqueous adhesive joint of one of the substrates into contact with a surface of the other substrate to form an assembly comprising the two substrates with the aqueous adhesive joint between them;

(e) placing the assembly in a press;

(f) and after removal from the press, recovering the assembly in the form of a laminated product.

Advantageously, step (b) for applying said adhesive joint comprises:
applying a layer of primer comprising an adhesion promoter P based on an encapsulated highly reactive aromatic isocyanate;
applying a layer of bicomponent adhesive based on a low reactivity non-blocked aliphatic isocyanate.

The present invention also pertains to a laminated product, especially a sole for footwear, comprising a first substrate (S1) and a second substrate (S2) adhering to each other by means of an aqueous adhesive joint (J), said aqueous adhesive joint comprising at least one encapsulated adhesion promoter as hereinbefore defined.

The present invention also pertains to an aqueous adhesive joint adhesion promoter for bonding a surface of a first substrate (S1) to a surface of a second substrate (S2), at least one of said substrates comprising a material (TPE-PA) comprising at least one thermoplastic elastomer (TPE) and/or at least one polyamide (PA), said adhesive joint comprising an encapsulated adhesion promoter as hereinbefore defined.

Advantageously, said at least one TPE/PA substrate comprises at least one material formed from amorphous or quasi-amorphous TPE and/or amorphous or quasi-amorphous polyamide. Said material preferably has an amorphous or quasi-amorphous TPE and/or amorphous or quasi-amorphous polyamide content representing 5% to 70% by weight of the total material weight.

Advantageously, said at least one amorphous or quasi-amorphous TPE is selected from: amorphous or quasi-amorphous COPEs and/or amorphous or quasi-amorphous TPUs and/or amorphous or quasi-amorphous PEBAs.

### DETAILED DESCRIPTION OF THE INVENTION

In accordance with the present invention, an adhesion promoter (P) is used in the composition of an aqueous adhesive joint applied to a substrate S1 based on (TPE-PA), which can augment the adhesion of said surface to any substrate S2 (identical to or different from substrate S1).

1—Substrate S1

The (TPE-PA) materials of substrate S1 of the invention comprise at least one thermoplastic elastomer (TPE) and/or at least one polyamide (PA) and/or a mixture of at least one TPE and at least one PA.

The term “thermoplastic elastomer polymer (TPE)” means a block copolymer comprising alternating blocks or segments termed hard or rigid and blocks or segments termed pliable or flexible.

Examples of copolymers with hard blocks and pliable blocks that may be cited are respectively (a) copolymers having polyester blocks and polyether blocks (also termed COPE, or copolyetheresters), (b) copolymers having polyurethane blocks and polyether or polyester blocks (also termed TPU, the abbreviation for thermoplastic polyurethanes) and (c) copolymers having polyamide blocks and polyether blocks (also termed PEBA according to IUPAC).

(a) COPEs, or copolyetheresters, are copolymers with polyester blocks and polyether blocks. They are constituted by pliable polyether blocks derived from polyetherdiols and rigid polyester blocks that result from the reaction of at least one carboxylic diacid with at least one short diol chain elongation motif. The polyester blocks and polyether blocks are bonded via ester linkages resulting from the reaction of the acid functions of the dicarboxylic acid with the OH functions of polyetherdiol. The concatenation of polyethers and diacids forms the pliable blocks while the concatenation of glycol or butanediol with the diacids forms the rigid blocks of the copolyetherester. The short diol chain elongation agent may be selected from the group constituted by neopentylglycol, cyclohexanedimethanol and aliphatic glycols with formula HO(CH₂)ₙOH wherein n is a whole number from 2 to 10.

Advantageously, the diacids are aromatic dicarboxylic acids containing 8 to 14 carbon atoms. Up to 50 mole % of the aromatic dicarboxylic acid may be replaced by at least one other aromatic dicarboxylic acid containing 8 to 14 carbon atoms, and/or up to 20 mole % may be replaced by an aliphatic dicarboxylic acid containing 2 to 14 carbon atoms.

Examples of aromatic dicarboxylic acids that may be cited are terephthalic, isophthalic, bibenzoic, naphthalene dicarboxylic acid, 4,4′-diphenylenedicarboxylic acid, bis(p-carboxyphenyl) methane acid, ethylenebis p-benzoic acid, 1-4 tetramethylene bis(p-oxybenzoic) acid, ethylenebis(p-oxybenzoic) acid, and 1,3-trimethylenebis(p-oxybenzoic) acid.

Examples of glycols that may be cited are ethylene glycol, 1,3-trimethylene glycol, 1,4-tetramethyleneglycol, 1,6-hexamethylene glycol, 1,3-propylene glycol, 1,8-octamethyleneglycol, 1,10-decamethylene glycol and 1,4-cyclohexylene dimethanol. Examples of copolymers having polyester blocks and polyether blocks are copolymers containing polyether motifs derived from polyetherdiols such as polyethylene glycol (PEG), polypropylene glycol (PPG), polytrimethylene glycol (PO3G) or polytetramethylene glycol (PTMG), carboxylic diacid motifs such as terephthalic acid and glycol (ethanediol) or butane-1,4-diol motifs. Such copolyetheresters have been described in patents EP 402 883 and EP 405 227. These polyetheresters are thermoplastic elastomers. They may contain plasticizers.

(b) TPUs that may be cited are polyetherurethanes that result from the condensation of pliable polyether blocks that are polyetherdiols and rigid polyurethane blocks derived from the reaction of at least one diisocyanate that may be selected from aromatic diisocyanates (for example MDI, TDI) and aliphatic diisocyanates (for example: HDI hexamethylenediisocyanate) with at least one short diol. The short diol chain elongation agent may be selected from the glycols cited above in the description of the copolyetheresters. The polyurethane blocks and the polyether blocks are bonded via linkages resulting from the reaction of the isocyanate functions with the OH functions of the polyetherdiol.

Polyesterurethanes resulting from the condensation of pliable polyester blocks that are polyester diols and rigid polyurethane blocks derived from the reaction of at least one diisocyanate with at least one short diol may also be cited. The polyester diols result from the condensation of carboxylic diacids advantageously selected from aliphatic dicarboxylic diacids containing 2 to 14 carbon atoms and glycols that are short diol chain elongation agents selected from the glycols cited above in the description of the copolyetheresters. They may contain plasticizers.

(c) PEBAs result from polycondensation of polyamide blocks having reactive ends with polyether blocks having reactive ends such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends, obtained by cyanoethylation and hydrogenation of aliphatic alpha-omega dihydroxylated polyoxyalkylene blocks termed polyetherdiols;
3) polyamide blocks having dicarboxylic chain ends with polyetherdiols; in this particular case, the products obtained are polyetherester amides.

The polyamide blocks with dicarboxylic chain ends originate, for example, from the condensation of polyamide precursors in the presence of a carboxylic diacid chain limiter.

The polyamide blocks with diamine chain ends originate, for example, from the condensation of polyamide precursors in the presence of a diamine chain limiter. The number average molar mass, Mn, of the polyamide blocks is in the range 400 to 20 000 g/mol, preferably in the range 500 to 10 000 g/mol.

The polymers with polyamide blocks and polyether blocks may also include randomly distributed motifs.

Advantageously, three types of polyamide blocks may be used.

In the first type, the polyamide blocks originate from the condensation of a carboxylic diacid, in particular containing 4 to 20 carbon atoms, preferably containing 6 to 18 carbon atoms and an aliphatic or aromatic diamine, in particular containing 2 to 20 carbon atoms, preferably containing 6 to 14 carbon atoms.

Examples of dicarboxylic acids that may be cited are 1,4-cyclohexyldicarboxylic acid, and butanedioic, adipic, azelaic, suberic, sebacic, dodecanedicarboxylic or octadecanedicarboxylic acid, and terephthalic and isophthalic acids, and also dimerized fatty acids.

Examples of diamines that may be cited are tetramethylenediamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM), 2-2-bis(3-methyl-4-aminocyclohexyl)propane (BMACP), para-aminodicyclo-hexylmethane (PACM), isophoronediamine (IPDA), 2,6-bis(aminomethyl)norbornane (BAMN) and piperazine (Pip).

Advantageously, the blocks are PA4.12, PA4.14, PA4.18, PA6.10, PA6.12, PA6.14, PA6.18, PA9.12, PA10.10, PA10.12, PA10.14 and PA10.18.

A second type of polyamide blocks results from the condensation of one or more alpha-omega amino carboxylic acids and/or one or more lactams containing 6 to 12 carbon atoms in the presence of a carboxylic diacid containing 4 to 12 carbon atoms or a diamine.

Examples of lactams that may be cited are caprolactam, oenantholactam and lauryllactam.

Examples of alpha-omega aminocarboxylic acids that may be cited are aminocaproic, amino-7-heptanoic, amino-11-undecanoic and amino-12-dodecanoic acid.

Advantageously the polyamide blocks of the second type are of polyamide 11, polyamide 12 or polyamide 6.

A third type of polyamide blocks results from the condensation of at least one alpha-omega aminocarboxylic acid (or a lactam), at least one diamine and at least one carboxylic diacid.

In this case, the PA blocks are prepared by polycondensation of:
linear aliphatic or aromatic diamine or diamines containing X carbon atoms;
carboxylic diacid or diacids containing Y carbon atoms; and
comonomer or comonomers {Z} selected from lactams and alpha-omega aminocarboxylic acids containing Z carbon atoms and equimolar mixtures of at least one diamine containing X1 carbon atoms and at least one carboxylic diacid containing Y1 carbon atoms, (X1, Y1) being different from (X, Y);
said comonomer or comonomers {Z} being introduced in a proportion by weight of up to 50%, preferably up to 20%, more advantageously up to 10% with respect to the entirety of the polyamide precursor monomers;
in the presence of a chain limiter selected from carboxylic diacids.

Advantageously, the carboxylic diacid containing Y carbon atoms is used as the chain limiter; it is introduced in excess with respect to the stoichiometry of the diamine or diamines.

In a variation of this third type, the polyamide blocks result from the condensation of at least two alpha-omega aminocarboxylic acids or at least two lactams containing 6 to 12 carbon atoms or a lactam and an aminocarboxylic acid not containing the same number of carbon atoms, optionally in the presence of a chain limiter.

Examples of aliphatic alpha-omega aminocarboxylic acids that may be cited are aminocaproic, amino-7-heptanoic, amino-11-undecanoic and amino-12-dodecanoic acids.

Examples of lactams that may be cited are caprolactam, oenantholactam and lauryllactam.

Examples of aliphatic diamines that may be cited are hexamethylenediamine, dodecamethylenediamine and trimethylhexamethylene diamine.

An example of a cycloaliphatic diacid that may be cited is 1,4-cyclohexyldicarboxylic acid.

Examples of aliphatic diacids that may be cited are butanedioic, adipic, azelaic, suberic, sebacic, dodecanedicarboxylic acid, dimerized fatty acids (said dimerized fatty acids preferably having a dimer content of at least 98%; they are preferably hydrogenated; they are sold under the trade name “PRIPOL” by the supplier “UNICHEMA”, or under the trade name EMPOL by the supplier HENKEL) and a,w diacid polyoxyalkylenes.

Examples of aromatic diacids that may be cited are terephthalic (T) acid and isophthalic (I) acid.

Examples of cycloaliphatic diamines that may be cited are isomers of bis(4-aminocyclohexyl)methane (BACM), bis(3-methyl-4-aminocyclohexyl)methane (BMACM), and 2-2-bis(3-methyl-4-aminocyclohexyl)propane(BMACP), and para-aminodicyclohexylmethane (PACM). The other diamines currently used may be isophoronediamine (IPDA), 2,6-bis(aminomethyl)norbornane (BAMN) and piperazine.

Examples of polyamide blocks of the third type that may be cited are as follows:
6.616, wherein 6.6 denotes hexamethylenediamine motifs condensed with adipic acid. 6 denotes motifs resulting from the condensation of caprolactam;
6.6/Pip.10/12, wherein 6.6 denotes hexamethylenediamine motifs condensed with adipic acid. Pip.10 denotes motifs resulting from the condensation of piperazine and sebacic acid. 12 denotes motifs resulting from the condensation of lauryllactam.
The proportions by weight are respectively 25 to 35/20 to 30/20 to 30, the total being 80, and advantageously 30 to 35/22 to 27/22 to 27, the total being 80. For example, the proportions 32/24/24 result in a melting point of 122° C. to 137° C.;
6.6/6.10/11/12, wherein 6.6 denotes hexamethylenediamine condensed with adipic acid. 6.10 denotes hexamethylenediamine condensed with sebacic acid. 11 denotes motifs resulting from the condensation of aminoundecanoic acid. 12 denotes motifs resulting from the condensation of lauryllactam.
The proportions by weight are respectively 10 to 20/15 to 25/10 to 20/15 to 25, the total being 70, and advantageously 12 to 16/18 to 25/12 to 16/18 to 25, the total being 70.
As an example, the proportions 14/21/14/21 result in a melting point of 119° C. to 131° C.

The polyether blocks may represent 5% to 85% by weight of copolymer having polyimide and polyether blocks. The mass Mn of the polyether blocks is in the range 100 to 6000 g/mol, preferably in the range 200 to 3000 g/mol.

The polyether blocks are constituted by alkylene oxide motifs. These motifs may, for example, be ethylene oxide motifs, propylene oxide motifs or tetrahydrofuran (which results in polytetramethylene glycol concatenations). Thus, the following are used: PEG (polyethylene glycol) blocks, i.e. constituted by ethylene oxide motifs, PPG (propylene glycol) blocks, i.e. constituted by propylene oxide motifs, PO3G (polytrimethylene glycol) blocks, i.e. constituted by polytrimethylene ether glycol motifs (such copolymers with polytrimethylene ether blocks have been described in patent U.S. Pat. No. 6,590,065), and PTMG blocks, i.e. constituted by tetramethylene glycol motifs also known as polytetrahydrofuran. Advantageously, PEG blocks or blocks obtained by oxyethylation of bisphenols, such as bisphenol A, for example, are used. These latter products have been described in patent EP 613 919.

The polyether blocks may also be constituted by ethoxylated primary amines. These blocks are also advantageously used. Examples of ethoxylated primary amines that may be cited are products with formula:

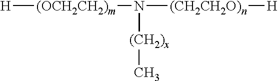

wherein m and n are in the range 1 to 20 and x is in the range 8 to 18. These products are commercially available under the trade name NORAMOX® from the supplier CECA and under the trade name GENAMIN® from the supplier CLARIANT.

The ether motifs (A2) are, for example, derived from at least one polyalkylene ether polyol, especially a polyalkylene ether diol, preferably selected from polyethylene glycol (PEG), polypropylene glycol (PPG), polytrimethylene glycol (PO3G), polytetramethylene glycol (PTMG) and mixtures thereof or copolymers thereof.

The pliable polyether blocks may comprise polyoxyalkylene blocks having NH₂ chain ends, such blocks possibly being obtained by cyanoacetylation of aliphatic alpha-omega dihydroxylated polyoxyalkylene blocks known as polyetherdiols. More particularly, it is possible to use Jeffamines (For example Jeffamine® D400, D2000, ED 2003, XTJ 542, commercial products from the supplier Huntsman. See also patents JP 2004346274, JP 2004352794 and EP1482011).

The polyetherdiol blocks are either used as they are and co-polycondensed with the polyamide blocks having carboxylic ends, or they are aminated in order to be transformed into polyether diamines and condensed with the polyamide blocks having carboxylic ends. They may also be mixed with polyamide precursors and a diacid chain limiter in order to produce polymers having polyamide blocks and polyether blocks containing motifs distributed in a random manner.

Said polymers may be prepared by the simultaneous reaction of polyether blocks and precursors of polyamide blocks; preferably, the polycondensation is carried out at a temperature of 180° C. to 300° C. As an example, it is possible to react the polyetherdiol, polyamide precursors and a diacid chain limiter. A polymer is obtained containing essentially polyether blocks, polyamide blocks of highly variable length, and also various reagents that have reacted in a random manner that are distributed in a random (statistical) manner along the polymer chain.

It is also possible to cause the polyether diamine, polyamide precursors and a diacid chain limiter to react. A polymer is obtained containing essentially polyether blocks, polyamide blocks of highly variable length, but also the various reagents that have reacted in a random manner that are distributed in a random (statistical) manner along the polymer chain.

However, they may also advantageously be prepared by a condensation reaction of polyether blocks with polyamide blocks.

The catalyst is defined as any product that can facilitate bonding of polyamide blocks and polyether blocks by esterification or by amidification. The esterification catalyst is advantageously a derivative of a metal selected from the group formed by titanium, zirconium and hafnium, or a strong acid such as phosphoric or boric acid. Examples of catalysts are those described in patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The general method for preparing PEBA copolymers in two steps with ester linkages between the PA blocks and the PE blocks is known and has been described, for example, in French patent FR 2 846 332. The general method for preparing the PEBA copolymers of the invention containing amide linkages between the PA blocks and the PE blocks is known and has been described, for example, in European patent EP 1 482 011.

The reaction for the formation of the PA block is normally carried out at between 180° C. and 300° C., preferably in the range 200° C. to 290° C., the pressure in the reactor being established at between 5 and 30 bars; it is maintained for approximately 2 to 3 hours. The pressure is slowly reduced by bringing the reactor back to atmospheric pressure, then the excess water is distilled off, for example over one or two hours.

Once the polyamide having carboxylic acid ends has been prepared, the polyether and a catalyst are then added. The polyether may be added in one or more batches, as can the catalyst. In an advantageous implementation, the polyether is initially added, whereupon the reaction of the OH ends of the polyether and the COOH ends of the polyamide commences with the formation of ester bonds and the elimination of water. As much water as possible is eliminated from the reaction medium by distillation, then the catalyst is introduced to complete the linkage of the polyamide blocks and the polyethylene glycol blocks. This second step is carried out with stirring, preferably under a vacuum of at least 6 mmHg (800 Pa) at a temperature such that the reagents and the copolymers obtained are in the molten state. As an example, this temperature may be in the range 100° C. to 400° C., usually in the range 200° C. to 300° C. The reaction is monitored by measuring the couple exerted by the molten polymer on the stirrer or by measuring the electrical power consumed by the stirrer. The end of the reaction is determined by the target value of the couple or the power.

During synthesis at the moment adjudged to be the most opportune, it is also possible to add one or more molecules used as an antioxidant, for example Irganox® 1010 or Irganox® 245.

The copolymers having polyamide blocks and polyether blocks may be prepared using any means that can key the polyamide blocks to the polyether blocks. In practice, two methods are essentially employed, one being a two-step method, the other a one-step method.

In the two-step method, the polyamide blocks are initially manufactured then in a second step, the polyamide blocks are keyed to the polyether blocks. In the one-step method, the polyamide precursors, chain limiter and polyether are mixed; a polymer containing essentially polyethylene glycol blocks, polyamide blocks of highly variable lengths and also the various reagents that have reacted in a random manner which are distributed in a random (statistical) manner along the polymer chain are obtained thereby. Irrespective of whether it is a one- or two-step method, it is advantageous to operate in the presence of a catalyst. The catalysts described in patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920, WO 04 037898, EP 1 262 527, EP 1 270 211, EP 1 136 512, EP 1 046 675, EP 1 057 870, EP 1 155 065, EP 0 506 495 and EP 0 504 058 may be used. In the one-step method, polyamide blocks are also manufactured; this is why it has been stated at the beginning of this paragraph that the copolymers could be prepared using any means for keying the polyamide blocks (PA block) to the polyether blocks (PE block).

Advantageously, the PEBA copolymers have PA blocks formed from PA 6, PA 11, PA 12, PA 6.12, PA 6.6/6, PA 10.10 and PA 6.14 and PE blocks formed from PTMG, PPG, PO3G and PEG.

(d) The polyamides are homopolyamides or copolyamides.

In accordance with a first type, the polyamides derive from the condensation of a carboxylic diacid, in particular containing 4 to 20 carbon atoms, preferably containing 6 to 18 carbon atoms, and an aliphatic or aromatic diamine, in particular containing 2 to 20 carbon atoms, preferably containing 6 to 14 carbon atoms.

Examples of dicarboxylic acids that may be cited are 1,4-cyclohexyldicarboxylic acid, and butanedioic, adipic, azelaic, suberic, sebacic, dodecanedicarboxylic or octadecanedicarboxylic acid and terephthalic and isophthalic acids, but also dimerized fatty acids.

Examples of diamines that may be cited are tetramethylene diamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM), 2-2-bis(3 -methyl-4-aminocyclohexyl)propane (BMACP), para-aminodicyclo-hexylmethane (PACM), isophoronediamine (IPDA), 2,6-bis (aminomethyl)norbornane (BAMN) and piperazine (Pip).

Advantageously, PA 4.12, PA 4,14, PA 4.18, PA 6.10, PA 6.12, PA 6.14, PA 6.18, PA 9.12, PA 10.10, PA 10.12, PA 10.14 and PA 10.18 are used.

The second polyamide type results from the condensation of one or more alpha-omega aminocarboxylic acids and/or one or more lactams containing 6 to 12 carbon atoms in the presence of a carboxylic diacid containing 4 to 12 carbon atoms or of a diamine.

Examples of lactams that may be cited are caprolactam, oenantholactam and lauryllactam.

Examples of alpha-omega aminocarboxylic acid that may be cited are aminocaproic, amino-7-heptanoic, amino-11- undecanoic and amino-12-dodecanoic acid.

Advantageously, the polyamides of the second type are formed from polyamide 11, polyamide 12 or polyamide 6.

A third type of polyamide results from the condensation of at least one alpha-omega aminocarboxylic acid (or a lactam), at least one diamine and at least one carboxylic diacid.

In this case, during a first step, the polyamide blocks PA are prepared by polycondensation of:
linear aliphatic or aromatic diamine or diamines containing X carbon atoms;
carboxylic diacid or diacids containing Y carbon atoms; and
comonomer or comonomers {Z} selected from lactams and alpha-omega aminocarboxylic acids containing Z carbon atoms and equimolar mixtures of at least one diamine containing X1 carbon atoms and at least one carboxylic diacid containing Y1 carbon atoms, (X1, Y1) being different from (X, Y);
said comonomer or comonomers {Z} being introduced in a proportion by weight of up to 50%, preferably up to 20%, more advantageously up to 10% with respect to the entirety of the polyamide precursor monomers.

Examples of aliphatic alpha-omega aminocarboxylic acids that may be cited are aminocaproic, amino-7-heptanoic, amino-11-undecanoic and amino-12-dodecanoic acid.

Examples of lactams that may be cited are caprolactam, oenanthoiactam and lauryllactam.

Examples of aliphatic diamines that may be cited are hexamethylenediamine, dodecamethylenediamine and trimethylhexamethylenediamine.

An example of a cycloaliphatic diacid that may be cited is 1,4-cyclohexyldicarboxylic acid.

Examples of aliphatic diacids that may be cited are butanedioic, adipic, azelaic, suberic, sebacic or dodecanedicarboxylic acid, dimerized fatty acids (these dimerized fatty acids preferably have a dimer content of at least 98%; they are preferably hydrogenated; they are sold under the trade name “PRIPOL” by the supplier “UNICHEMA”, or under the trade name EMPOL by the supplier HENKEL) and α,γ-diacid polyoxyalkylenes.

Examples of aromatic diacids that may be cited are terephthalic (T) acid and isophthalic (I) acid.

Examples of cycloaliphatic diamines that may be cited are isomers of bis(4-aminocyclohexyl)methane (BACM), bis(3-methyl-4-aminocyclohexyl)methane (BMACM), and 2-2-bis(3-methyl-4-aminocyclohexyl)propane (BMACP), and para-aminodicyclohexylmethane (PACM). The other diamines in routine use may be isophoronediamine (IPDA), 2,6-bis(aminomethyl)norbornane (BAMN) and piperazine.

Examples of the third type of polyamide that may be cited are as follows:
PA6.6/6, wherein 6.6 denotes hexamethylenediamine motifs condensed with adipic acid. 6 denotes motifs resulting from the condensation of caprolactam;
PA6.6/Pip.10/12, wherein 6.6 denotes hexamethylenediamine motifs condensed with adipic acid. Pip. 10 denotes motifs resulting from the condensation of piperazine and sebacic acid. 12 denotes motifs resulting from the condensation of lauryllactam. The proportions by weight are respectively 25 to 35/20 to 30/20 to 30, the total being 80, and advantageously 30 to 35/22 to 27/22 to 27, the total being 80. For example, the proportions 32/24/24 result in a melting point of 122° C. to 137° C.;
PA6.6/6.10/11/12, wherein 6.6 denotes hexamethylenediamine condensed with adipic acid. 6.10 denotes hexamethylenediamine condensed with sebacic acid. 11 denotes motifs resulting from the condensation of aminoundecanoic acid. 12 denotes motifs resulting from the condensation of lauryllactam. The proportions by weight are respectively 10 to 20/15 to 25/10 to 20/15 to 25, the total being 70, and advantageously 12 to 16/18 to 25/12 to 16/18 to 25, the total being 70. As an example, the proportions 14/21/14/21 result in a melting point of 119° C. to 131° C.

The substrate S1 is selected from the (TPE-PA) compounds defined above and/or mixtures thereof.

Clearly, the substrate S1 may also include additives such as catalysts, in particular based on phosphorus, UV stabilizers, dyes, nucleation agents, plasticizers, shock resistance improving agents, antioxidants, release agents, adjuvants or processing/operating auxiliaries, especially stearates such as calcium stearate, zinc stearate or magnesium stearate, fatty acids, fatty alcohols, esters of the montanic ester type, sebacic acid esters, esters of dodecanedioic acid, polyolefin waxes, amide waxes, stearamides such as ethylenebisstearamide (EBS), erucamides, fluorinated additives, especially of the Dyneon Dynamer FX 5914 or FX 5911 type.

Advantageously, said TPE-PA substrate comprises at least one amorphous or quasi-amorphous polymer, i.e. an adhesion promoter (A) as described in the Applicant's French patent application FR 07/58478.

This adhesion promoter polymer is primarily amorphous. It is advantageously selected from amorphous or quasi-amorphous compounds from the TPE category described above and/or from amorphous or quasi-amorphous polyamides. It may advantageously include a mixture of these two types of amorphous or quasi-amorphous compounds (TPE or PA).

Said at least one amorphous or quasi-amorphous TPE is preferably selected from: amorphous or quasi-amorphous COPEs and/or amorphous or quasi-amorphous TPUs and/or amorphous or quasi-amorphous PEBAs.

Advantageously, the TPE based material that forms the substrate S1 has an amorphous or quasi-amorphous TPE polymer content and/or amorphous or quasi-amorphous polyamide content that represents 1% to 99% by weight of the total weight of said material. Preferably, said content represents 3% to 90% by weight of the total weight of said material. More preferably, this content represents 5% to 70% by weight of the total weight of said material.

Preferably, the adhesion promoters based on amorphous or quasi-amorphous polyamide (PA) and/or based on amorphous or quasi-amorphous polyether-block-amide (PEBA) are used.

In accordance with a preferred implementation of the invention, the material of the substrate S1 is based on PEBA and further comprises an adhesion promoter polymer (A) based on amorphous or quasi-amorphous PA and/or on amorphous or quasi-amorphous PEBA.

Concerning amorphous or quasi-amorphous PAs:

In one implementation of the invention, the polyamides with motifs A1 in the composition of the adhesion promoter (A) have a crystallinity such that the enthalpy of fusion during the second heating of an ISO DSC (delta Hm(2)) is less than or equal to 10 J/g, the mass being with respect to the quantity of amide motifs contained or of polyamide contained therein, said fusion being that of the amide motifs; finally, it may have a crystallinity (termed intermediate) such that the enthalpy of fusion during the second heating of an ISO DSC (delta Hm(2)) is in the range 10 to 30 J/g, preferably in the range 10 and 25 J/g, the mass being with respect to the quantity of amide motifs contained or of polyamide contained therein, said fusion being that of the amide motifs. Such materials are products with a behavior intermediate between amorphous or essentially amorphous polymers, i.e. with a second heat enthalpy of fusion in the range 0 to 10 J/g, which are no longer in the solid state above their Tg, and genuinely semi-crystalline polymers, which are polymers that remain in the solid state, i.e. retain their shape above their Tg. These products with intermediate behavior are thus in a more or less solid state, but are readily deformable beyond their Tg.

The term “delta Hm(2)” means the enthalpy of fusion during the second heating of an ISO standard DSC (“Differential Scanning Calorimetry”)

The polyamides may be mainly constituted by an equimolar combination of at least one diamine and at least one carboxylic or aromatic or cycloaliphatic diacid, the diamines being mainly cycloaliphatic, the amide motifs possibly comprising at least one other polyamide comonomer of the amino acid or lactam type or of the X,Y type (X=aliphatic diamine, Y=aliphatic diacid).

Advantageously, the cycloaliphatic diamine or diamines may be selected from bis(3-methyl-4-aminocyclohexyl)-methane (BMACM), para-aminodicyclohexylmethane (PACM), isophoronediamine (IPD), bis(4-aminocyclohexyl)methane (BACM), 2,2-bis(3-methyl-4-aminocyclohexyl)propane (BMACP), and 2,6-bis(aminomethyl)norbornane (BAMN).

A non-cycloaliphatic diamine may form part of the composition of the amide motif monomers (A1). Examples of non-cycloaliphatic diamines that may be cited are linear aliphatic diamines such as 1,4-tetramethylene diamine, 1,6-hexamethylenediamine, 1,9-nonamethylenediamine or 1,10-decamethylenediamine.

The aliphatic carboxylic diacid or diacids may be selected from aliphatic carboxylic diacids containing 6 to 36 carbon atoms, preferably 9 to 18 carbon atoms, in particular 1,10-decanedicarboxylic acid (sebacic acid), 1,12-dodecanedicarboxylic acid, 1,14-tetradecanedicarboxylic acid or 1,18-octadecanedicarboxylic acid.

An aromatic or cycloaliphatic carboxylic diacid may form part of the composition of the amide motif monomers. In this case, the carboxylic diacid is selected from aromatic diacids, in particular isophthalic (I) acid, terephthalic (T) acid and mixtures thereof.

The alpha-omega aminocarboxylic acid or amino acid is, for example, selected from amino caproic acid, amino-7-heptanoic acid, amino-11-undecanoic acid and amino-12-dodecanoic acid.

The polyamide blocks are, for example, selected from BMACM.6, BMACM.9, BMACM.10, BMACM.12, BMACM.14, BMACM.16, BMACM.18 and mixtures thereof.

The number average molecular mass of the polyamide blocks is advantageously in the range 500 to 12 000 g/mol, preferably in the range 2000 to 6000 g/mol.

Concerning amorphous or quasi-amorphous PEBAs:

In a second implementation of the invention, an adhesion promoter copolymer (A) comprises polyamide motifs (A1) and ether block motifs (A2) and may be in the form of polyamide-polyether blocks.

The amorphous or quasi-amorphous polyamide motifs (A1) are those which were described in the preceding paragraph (see amorphous or quasi-amorphous PA).

As an example, the polyether block motifs (A2) are derived from at least one polyalkylene ether polyol, especially a polyalkylene ether diol, preferably selected from polyethylene glycol (PEG), polypropylene glycol (PPG), polytrimethylene glycol (PO3G), polytetramethylene glycol (PTMG) and mixtures thereof or copolymers thereof.

The pliable polyether blocks may comprise polyoxyalkylene sequences with NH₂ chain ends, such sequences possibly being obtained by cyanoacetylation of aliphatic alpha-omega dihydroxylated polyoxyalkylene sequences known as polyetherdiols. More particularly, it is possible to use Jeffamines (For example Jeffamine® D400, D2000, ED 2003, XTJ 542, commercial products from the supplier Huntsman. See also patents JP 2004346274, JP 2004352794 and EP 1 482 011).

The number average molecular mass of the polyether blocks is advantageously in the range 200 to 4000 g/mol, preferably in the range 300 to 1100 g/mol.

The adhesion promoter copolymer (A) may be prepared using the following method in which:
in a first step, polyamide PA blocks are prepared by polycondensation of:
   diamine or diamines;
   carboxylic diacid or diacids; and
if appropriate, comonomer or comonomers selected from lactams and alpha-omega aminocarboxylic acids;
   in the presence of a chain limiter selected from carboxylic diacids; then
in a second step, the polyamide PA blocks obtained are reacted with the polyether PE blocks in the presence of a catalyst.

The general method for preparing the copolymers of the invention in two steps is known and has been described, for example, in French patent FR 2 846 332 and in European patent EP 1 482 011.

The reaction for forming the PA block is normally carried out in the range 180° C. to 300° C., preferably in the range 200° C. to 290° C., the pressure in the reactor being between 5 and 30 bars, and held for approximately 2 to 3 hours. The pressure is reduced slowly, bringing the reactor back to atmospheric pressure, then the excess water is distilled off, for example over one or two hours.

Once the polyamide having carboxylic acid ends has been prepared, the polyether and a catalyst are then added. The polyether may be added in one or more batches, like the catalyst. In one advantageous implementation, the polyether is added initially, whereupon the reaction of the OH ends of the polyether and the COOH ends of the polyamide commences with the formation of ester linkages and the elimination of water. As much water as possible is eliminated from the reaction medium by distillation, then the catalyst is introduced to complete the linkage of the polyamide blocks and the polyether blocks. This second step is carried out with stirring, preferably under a vacuum of at least 15 mmHg (2000 PA) at a temperature such that the reagents and the copolymers obtained are in the molten state. As an example, this temperature may be in the range 100° C. to 400° C., usually in the range 200° C. to 300° C. The reaction is followed by measuring the couple exerted by the molten polymer on the stirrer or by measuring the electrical power consumed by the stirrer. The end of the reaction is determined by the target value of the couple or the power.

During synthesis, at a time adjudged to be opportune, it is also possible to add one or more molecules used as an antioxidant, for example Irganox® 1010 or Irganox® 245.

It is also possible to consider a method for the preparation of copolymer (A) wherein all of the monomers are added at the start, i.e. in a single step, to carry out polycondensation of:
diamine or diamines;
carboxylic diacid or diacids; and
if appropriate, the other polyamide cornonomer or comonomers;
in the presence of a chain limiter selected from carboxylic diacids;
in the presence of PE (polyether) blocks;
in the presence of a catalyst for the reaction between the pliable PE blocks and the PA blocks.

Advantageously, the chain limiter used is said carboxylic diacid, which is introduced in excess with respect to the stoichiometry of the diamine or diamines.

Advantageously, the catalyst used is a derivative of a metal selected from the group formed by titanium, zirconium and hafnium or a strong acid such as phosphoric acid, hypophosphorous acid or boric acid.

The polycondensation may be carried out at a temperature of 240° C. to 280° C.

Concerning the method for incorporating the adhesion promoter into the solution of the substrate S1:

The adhesion promoter (A) may be introduced into the composition of substrate S1 by a compounding operation or using a masterbatch containing the adhesion promoter polymer, or during polycondensation of TPE, or by incorporation by dry mixing with the material based on TPE during transformation of injection molded parts. The adhesion promoter may also be incorporated into the surface of the portion of the substrate to be bonded via an overmolding operation.

Advantageously, incorporation of the adhesion promoter in accordance with the invention does not alter the intrinsic mechanical properties of the matrix of the substrate S1, irrespective of the method for incorporating the promoter into the substrate matrix.

2—Substrate S2

Substrate S2 may be identical to or different from substrate S1.

Substrate S2 is selected from the TPE-PA substrates defined above and/or mixture(s) thereof, homopolymers and copolymers such as polyolefins, polyamines, polyamides, polyesters, polyethers, polyesterethers, polyimides, polycarbonates, phenolic resins, polyurethanes, cross-linked or not cross-linked, especially foams, poly (ethylene-vinyl acetate), natural or synthetic elastomers such as polybutadienes, polyisoprenes, styrene-butadiene-styrene (SBS), styrene-butadiene-acrylonitrile (SBN), polyacrylonitriles, natural or synthetic fabrics, in particular fabrics formed from organic polymer fibers, such as fabrics formed from fibers of polypropylene, polyethylene, polyesters, polyvinyl alcohol, polyvinyl acetate, polyvinyl chloride, polyamide, fabrics formed from glass fibers or carbon fibers, as well as materials such as leather, paper or board.

3—Cleaning Solutions

The solutions for cleaning the surface of the substrates to be bonded are those generally used to eliminate impurities, fats, or foreign agents that may alter the adhesion of the primers and/or the adhesives on the substrates.

These cleaning solutions may also contain additives such as wetting agents or detergents to encourage the elimination of polluting substances and/or to improve the wettability of the supports.

Examples that may be cited are water-based cleaning solutions, solutions based on aliphatic organic solvents or solutions based on aromatic solvents and mixtures thereof composed of 2 or more than 3 of the above solvents.

The principal groups of solvents are:
water;
ketones (for example: acetone, methylethylketone);
alcohols (for example: methanol, ethanol, isopropanol, glycols);
esters (for example: acetates, agro-solvents);
ethers (for example: ethyl ethers, THF, dioxane);
glycol ethers;
aromatic hydrocarbons (benzene, toluene, xylene, cumene);
petroleum solvents (apart from aromatics: alkanes, alkenes);
halogenated hydrocarbons: (chlorinated, brominated or fluorinated);
particular solvents (amines, amides, terpenes).

The organic solvents or solutions based on water and/or based on organic solvents are carefully selected in order to reduce solvent emissions as much as possible, and to reduce the risks linked to toxicity and ecotoxicity. Advantageously, the organic type cleaning solvent selected is methylethylketone (MEK,) or an aqueous based detergent solution (dispersion or emulsion).

The cleaning method may be carried out using techniques that are in routine use in the field, such as: brush application, spraying, immersion, etc. The preferred technique for cleaning a (TPE-PA) substrate is immersion as it ensures homogeneity of the effects of adhesion promotion as well as a uniform degree of bonding. Cleaning by immersion can most easily avoid contamination of the substrate by any impurities. Furthermore, the immersion technique is perfectly adapted to continuous bonding methods on an assembly line. Alternatively, cleaning with a brush or using a textile may be employed, but it generates soil and waste.

Next, the cleaned surface is “dried” at a temperature in the range 50° C. to 140° C., in order to be able to apply the adhesive joint directly to the cleaned surface; said adhesive joint may, for example, comprise a first layer of primer and a layer of adhesive applied to said first layer of primer.

4—Adhesive Joint (J)

In general, the substrates (S1) based on (TPE-PA) are assembled by bonding with other substrates (S2) by means of an adhesive joint. The adhesive joint may be applied in one or more layers of adhesive(s) with different compositions or otherwise to at least one of the surfaces of the substrates to be bonded. The adhesive joint may further comprise a first layer of primer, applied to one substrate before application of the layer(s) of adhesive, in order to improve wetting of the surface of the substrate by the adhesive. The adhesive and the primer may have compositions that may or may not be alike, the primer usually having a viscosity that is lower than that of the adhesive. One of the advantages of the invention is that both the adhesion primer(s) and the adhesive(s) used are mainly aqueous.
Concerning the adhesives applied to the substrate(s) based on (TPE-PA):

The adhesives used may be monocomponent containing, for example, a polymer (functionalized or not) and a cross-linking agent in the same dispersion in water. The adhesives may also be multicomponent adhesives. They are usually bicomponent adhesives comprising a first component that may or may not be a functionalized resin (for example hydroxylated, carboxylated, epoxy, amine, amide, etc.), in dispersion or in solution in an organic solvent and/or in water, and a second component (cross-linking agent) such as a solution of isocyanate in an organic solvent or a pure isocyanate or a dispersion of isocyanate in water. In order to limit solvent emission, the bonding method of the invention preferably employs aqueous solutions.

Clearly, other types of aqueous based adhesive may be used. As an example, “contact” adhesives may be used, which act by fusion of the two layers in contact.
Concerning the primers applied to the (TPE-PA) based substrates:

Monocomponent or multicomponent primer compositions may be used in the present invention. The preferred primers for use in the present invention are generally bicomponent compositions wherein the first component is a rein (functionalized or otherwise) in solution in an organic solvent or in an aqueous solvent or in dispersion in an aqueous solvent, and the second component (cross-linking agent), which is added to the first component just before use of the primer, is an isocyanate or a mixture of isocyanates, also in solution in an organic solvent or in an aqueous solvent or in dispersion in an aqueous solvent.

Depending on the composition of the solvent for said primers, this step for application of the primer thus involves more or fewer emissions of organic solvents into the atmosphere. Preferably, then, the bonding method of the invention employs aqueous solutions. Clearly, any other cross-linking agent may be used, for example hexamethoxymethylmelamine (HMMM), which is appropriate in the case of primers containing water.

5—Adhesion Promoter

Said adhesion promoter of the invention comprises at least one organic molecule comprising one or more highly reactive isocyanate groups (or functions) (I). Said molecule is encapsulated, or at least its highly reactive isocyanate groups are.

The term “molecules having highly reactive isocyanate groups that can form part of the composition of the adhesion promoter of the invention” means any diisocyanates and polyisocyanates that are solid at ambient temperature, with a melting point of more than 40° C., and available in the form of a powder with a mean particle size of less than 200 μm, preferably less than 100 μm. Said molecules having isocyanate groups of the present invention may be aliphatic, cycloaliphatic, heterocyclic or aromatic.

Preferably, the molecules having highly reactive isocyanate groups of the present invention are aromatic molecules.

Particularly appropriate examples of molecules having highly reactive isocyanate functions for use in the composition of the adhesion promoter of the invention that may be cited are: 4,4′-methylene di(phenylisocyanate) (=diphenylmethane-4,4′-diisocyanate, MDI), isophorone diisocyanate (IPDI), 2,4-toluene diisocyanate (TDI), toluylene diisocyanate-uretdione (=TDI-uretdione, TDI-U, dimeric 1-methyl-2,4-phenylene diisocyanate), TDI-urea, naphthalene-1,5-diisocyanate (NDI), 3,3′-dimethyl biphenyl-4,4′-diisocyanate (TODI) and IPDI isocyanurate (IPDI-T), and mixtures thereof.

Preferably, 2,4-toluene diisocyanate (TDI) or the trimer of isophorone diisocyanate (IPDI) is used.

Said molecules are encapsulated by reacting the isocyanates with aliphatic amines to form urea functions. In addition, in accordance with the invention, the term “organic molecules having isocyanate function(s) blocked by encapsulation” means solid, very finely milled particles comprising molecules having isocyanate functions (I) deactivated by aliphatic amines, which thereby create a protective layer or capsule comprising urea functions on the surface of said solid particles.

Examples of aliphatic amines forming an agent encapsulating the isocyanates as described above that may be cited are: 2-pentamethylene-1,5-diamine and its isomers and homologs such as, for example, 1,6-hexamethylene diamine, di-sec-butylamine; ethylene diamine; 1,3-propylene diamine; diethylene triamine; triethylene tetramine; 3,3′-dimethyl-4,4′-diaminodicyclohexylmethane; methylnonane diamine; isophorone diamine; 4,4′-diaminodicyclohexylmethane; or an alkanol-amine or -diamine, such as ethanolamine or diethanolamine.

Preferred aliphatic amines that may be used are 2- pentamethylene-1,5-diamine and its isomers and homologs such as, for example, 1,6-hexamethylene diamine.

Because of this encapsulation, the isocyanate groups are deactivated, i.e. they are not reactive with other molecules. Said encapsulation prevents the isocyanate functions from reacting with each other or with other molecules such as water, resins (polyurethanes) and other molecules that might react with the isocyanate functions.

The adhesion promoter of the invention comprising such molecules may be incorporated in aqueous dispersion and/or mixed with resins, in particular polyurethanes, to form a monocomponent adhesive.

In accordance with the invention, the adhesion promoter is preferably incorporated into the aqueous primer and/or the aqueous adhesive that is intended to come into contact with the TPE-A support in an amount of 0.5% to 20% by weight of active substance, preferably in the range 0.5% to 10% by weight of the active substance with respect to the total mass of primer and/or adhesive.

The adhesion promoter is “activated” during the operation for curing, also termed drying, the primer or the adhesive at a temperature in the range 50° C. to 140° C., preferably in the range 70° C. to 120° C. This activation is carried out directly after applying the primer or the adhesive to the substrate, without necessitating an intermediate step for evaporation of water, and it precedes bringing the substrates into contact using the press.

During thermal activation, the protective capsule comprising the surface urea functions opens up and releases the isocyanate functions, which means that they can react both with the chemical functions available on the surface of the (TPE-PA) substrates and with any other components of the adhesives; they thus act as the adhesion promoter.

Such organic molecules having isocyanate function(s) blocked by encapsulation are available in the solid state or in the pre-dispersed state. In this latter case, dispersion agents, wetting agents or viscosity modifying agents may be introduced to provide the dispersions with stability.

These organic molecules having isocyanate function(s) blocked by encapsulation are, for example, commercially available from the supplier Bayer Material Science under the trade name Dispercoll BL XP 2514 (deactivated TDI dimer) and Desmodur LP BUEJ 471 or Desmodur Z XP 2589 (deactivated IPDI trimer).

Encapsulated TDI type polyisocyanates are preferably used.

The adhesion promoter of the invention may be used alone or in combination with one (or more) other isocyanate(s), blocked or not blocked, encapsulated or not encapsulated, in order to control the reactivity and the physico-chemical properties of the adhesive joint.

Bonding onto TPE-PA supports requires highly reactive adhesives. However, adhesives based on highly reactive isocyanates form very rigid layers, which cannot readily withstand the deforming loadings linked to sports footwear.

In a preferred embodiment of the present invention, the following are applied in succession to the surface of a substrate:
a layer of primer comprising an adhesion promoter based on an encapsulated highly reactive aromatic isocyanate;
a layer of conventional bicomponent adhesive (based on a low reactivity, non-blocked aliphatic isocyanate).

Thus, after activation, the primer forms a highly reactive adhesion layer with the substrate surface. Since the layer of primer is frangible on bending, a very thin layer of primer is sufficient.

Because of its great affinity for the primer, the adhesive provides the adhesion proper. The layer of adhesive is in itself highly flexible.

In accordance with another embodiment, molecules with non-blocked isocyanate groups are mixed into the composition of the primer and/or the adhesive with molecules having encapsulated isocyanate groups of the adhesion promoter of the invention. Using a promoter according to the invention in existing primer and/or adhesive compositions (monocomponent or multi component) means that the compromise between adhesion to TPE-PA substrates and pliability of the adhesive joints and the laminates obtained can be adjusted. The encapsulated highly reactive isocyanates provide adhesion to the TPE-PA material, while the non-blocked and low reactivity isocyanates on the TPE-PA ensure cross-linking of the adhesive as well as the chemical hold and pliability of the adhesive joint obtained.

According to the present invention, it has been shown that, surprisingly, the adhesion promoter could readily be used without the need for a prior step for evaporating off the water from the adhesive joint before bonding. As a result, bonding is carried out directly after applying the adhesive.

The method of the invention also means that encapsulated aromatic isocyanates and non-blocked aliphatic isocyanates can be used in a synergistic manner, in contrast to the existing method for latent adhesives.

The method of the invention allows an adhesion promoter to be incorporated into the primer or into the adhesive or both into the primer and into the adhesive. In this latter case, the affinity between the adhesive and the primer is improved.

Preferably, the adhesion promoter of the present invention is used in the portion of the adhesive joint that is applied directly to the substrate surface, i.e. in the primer or in the adhesive if no primer is used.

Clearly, these preferred embodiments of the present invention do not exclude other possibilities for using the adhesion promoter in the adhesive joint, such as using it in the adhesive but not in the intermediate primer between the substrate and the adhesive.

6—Method for Manufacturing a Laminate

The present invention also concerns a method for manufacturing a laminate. In accordance with the present invention, bonding of the types described of substrates (S1) onto substrates (S2) for the manufacture of laminates comprises the steps described below.

In accordance with a first advantageous implementation in the case in which substrates S1 and S2 are formed from (TPE-PA) that may or may not be of the same nature, the method for manufacturing a laminate comprises:

(a) cleaning surfaces S1and S2 with a cleaning solution;

(b) drying at a temperature in the range 20° C. to 120° C.;

(c) optionally, applying a layer of aqueous based primer comprising the promoter of the invention to S1 and/or S2;

(d) curing the primer layer(s) if necessary at a temperature in the range 60° C. to 150° C. for 5 minutes, to activate the isocyanate groups of the promoter;

(e) applying at least one layer of aqueous based adhesive onto a surface of at least one of the two substrates and/or onto the surface of the primer layer(s) if already deposited on S1 and/or S2.

During said step (e), said adhesive comprises the adhesion promoter of the invention in the case in which no primer has already been applied; or in the case in which a primer with no adhesion promoter has been applied. In the case in which a primer comprising an adhesion promoter of the invention has already been applied in step (c), said adhesive may optionally also comprise an adhesion promoter according to the invention, for greater affinity with the primer and thus greater adhesion efficacy;

(f) curing the layers of adhesives at a temperature of the order of 60° C. to 150° C. for 5 minutes to activate the adhesion promoter;

(g) as soon as activation of the surface comprising the layer of aqueous adhesive of one of the substrates is complete, bringing it into contact with the surface, which may or may not comprise a layer of adhesive, of the other substrate;

(h) pressing the assembly; then removing from the press;

(i) recovering the laminated product.

The pressure applied during the pressing step is in the range 1 to 15 kg/cm², preferably in the range 3 to 10 kg/cm².

Pressing may be carried out in a humid atmosphere with the air having a relative humidity HR³ of more than 5%, preferably more than 10%, more preferably more than 20%.

In accordance with a second advantageous implementation of the present invention, in the case in which S1 is formed from (TPE-PA) and the chemical nature of S2 is other than (TPE-PA), the method for manufacturing a laminate comprises:

(a) cleaning the surface S1 with a cleaning solution;

Cleaning and/or preparation of substrate S2 is adapted to the nature of the substrate and uses normal techniques that are known to the skilled person;

(b) drying S1 at a temperature in the range 20° C. to 140° C.;

(c) optional (i.e. non essential) application of a layer of aqueous based primer to S1 followed, if appropriate, by curing said primer, said primer comprising an adhesion promoter according to the invention;

(d) applying or not applying a layer of an appropriate primer to the substrate S2 followed, if appropriate, by curing said primer;

(e) applying a layer of aqueous based adhesive to the surface of S1 or to the surface of the primer that may already have been deposited on S1, said adhesive comprising the adhesion promoter according to the invention in the case where no primer has already been applied, or in the case in which a primer with no adhesion promoter has been applied. In the case in which a primer comprising an adhesion promoter according to the invention has already been applied in step (c), said adhesive may optionally also comprise an adhesion promoter according to the invention, for greater affinity with the primer and thus greater adhesion efficiency;

(f) curing the layer of adhesive at a temperature of the order of 60° C. to 150° C.;

(g) applying a layer of adhesive to the surface of S2 or to the surface of the primer if it has already been deposited on S2. Said adhesive is preferably aqueous and compatible with the adhesive deposited on the substrate S1. Advantageously, said adhesive is identical to that deposited on the substrate S1;

(h) curing the adhesive. If it is the same adhesive as with step (f), curing is carried out at the same temperature as in (f). If it is another adhesive, the curing temperature is a function of the support and the recommendations of the formulator;

(i) bringing the surface comprising the layer of activated aqueous adhesive of substrate S1 into contact with the surface comprising the layer of activated adhesive of substrate S2;

(j) pressing the assembly; then removing it from the press;

(k) recovering the laminated product.

The pressure applied during the pressing step is in the range 1 to 15 kg/cm², preferably in the range 3 to 10 kg/cm².

Pressing may be carried out in a humid atmosphere, the air having a relative humidity HR³ of more than 5%, preferably more than 10% and more preferably more than 20%.

The presses used in the method of the invention are presses that are conventional in the laminate manufacturing field.

When applied to the manufacture of laminates, incorporating an adhesion promoter into the primer and/or into the adhesive of the present invention thus means that a method can be used that is both:
reliable, meaning that adhesion of (TPE-PA)s with aqueous adhesive joints is improved; and
safe, since a completely aqueous adhesive joint (adhesive and/or primer included) is used.

According to an advantageous implementation of the invention, the surfaces of the substrates to be bonded are cleaned with an aqueous based detergent solution, the adhesive used is aqueous, along with any primer used, such that solvent emission during the course of the method of the invention is considerably reduced.

### EXAMPLES

The following examples illustrate the present invention without limiting its scope. In the examples, unless otherwise indicated, all of the percentages and portions are expressed by weight.

Substrates:

PEBAX® 5533: type PA12-PTMG PEBA (polyamide 12-polytetramethylene glycol), grade PEBAX® 5533 SP01 in the tables, sold by the supplier ARKEMA.

PEBAX® 7033: type PA12-PTMG PEBA (polyamide 12-polytetramethylene glycol), sold by the supplier ARKEMA.

PEBAX® 7033 is harder than PEBAX® 5533

Geometry of Substrates:

Width: 15 mm;

Length: 100 mm;

Thickness: 1 mm.

In the following examples, the layer of primer had a thickness (after curing) of 1 to 30 μm and the layer of adhesive had a thickness (after curing) of 30 to 50 μm.

Adhesion Promoter:

Dispercoll® BL XP 2514: aromatic dimeric TDI type isocyanate deactivated by encapsulation, sold by the supplier Bayer Material Science.

Cleaning Solution:

MEK: METHYL ETHYL KETONE (synonym: 2-butanone).

Primers:

W104: aqueous based primer sold by the supplier DONGSUNG under the trade name “Aquace® W104” (dry extract−30 min at 150° C.=40% by weight of polyurethane);

ARF 40: aliphatic cross-linking agent: ARF-40® sold by the supplier DONGSUNG. (Dry extract−30 min at 150° C.=83.5% by weight of polyisocyanate);

Dply 171-2: solvent base primer sold by the supplier DONGSUNG under the trade name “D-Ply® 171-2” (dry extract−30 min at 150° C.=10% by weight).

RFE® cross-linking agent sold by the supplier Bayer: solution of tris(p-isocyanatophenyl) thiophosphate in ethyl acetate (dry extract−30 min at 150° C.=26.9% by weight in ethyl acetate).

Adhesive:

W01: aqueous adhesive sold by the supplier DONGSUNG under the trade name “Aquace® W01”: Solution of modified polyurethane in MEK+ethyl acetate solvent (dry extract−30 min at 150° C.=46.9% by weight of polyurethane);

ARF 40: ARF-40® cross-linking agent sold by the supplier DONGSUNG. (dry extract−30 min at 150° C.=83.5% by weight of polyisocyanate).

Equipment:

The tests were carried out using the following equipment:
hydraulic press (8 to 15 kg/cm²);
Heraeus convection oven set at 70° C., ventilated;
ISO 34 punch;
Pneumatic press to cut specimens.

General Operational Assembly Mode:

Examples:

Preparation of Substrate (S1)
cleaning solution: MEK;
cleaning with cloth or immersing a smooth face of substrate S1, cleaning time: 3 to 20 s;
drying for 5 minutes at temperatures in the range 20° C. to 120° C.;
application of an aqueous primer (except in the case of the examples of the invention Nos: 26 and 27) using a brush.
The aqueous primer comprised a first component and a second component. In the tests shown in the various tables, the second component corresponded to 5% by weight of cross-linking agent with respect to the total primer weight. This second component corresponded either to ARF-40® for comparative tests Nos: 1, 2, 3, 4, 5, 6, and 7 or to Dispercoll BL XP 2514 for the examples of the invention, Nos: 10, 11, 12, 13, 14, 15, 16, 17, 18 and 22;
curing for 5 minutes at 60° C. to 150° C. in a ventilated oven;
cooling for 2 minutes to ambient temperature;
application of aqueous adhesive using a brush.
Similarly, in these tests, the aqueous adhesive comprised a first component and a second component. In the tests shown in the various tables, the second component corresponded to 5% by weight of cross-linking agent with respect to the total primer weight. This second component corresponded to ARF-40® for tests Nos: 1 to 25 or Dispercoll BL XP 2514 for the examples according to the invention Nos: 26 and 27 which included an adhesive with an adhesion promoter according to the invention;
curing: 5 minutes at 70° C. in a ventilated oven, except for the examples of the invention Nos: 26 and 27.
Preparation of Substrate (S2)

In the case in which the substrate S2 is of a (TPE-PA) nature and the primer used is an aqueous based primer, the preparation of substrate S2 is identical to that of the substrate S1 defined in the preceding paragraph entitled: Preparation of support S1.

In the case in which the substrate S2 is of a (TPE-PA) nature and the primer is solvent based, the preparation of the substrate S2 is as follows:
cleaning a smooth face of the substrate S2 with MEK solvent;
cleaning time 3 s to 20 s;
drying for 2 minutes at ambient temperature;
applying primer Dply 171-2 (+5% of RFE® cross-linking agent) using a brush;
drying for 5 minutes at 70° C. in a ventilated oven;
cooling for 2 minutes to ambient temperature;
applying adhesive W01 (+5% of ARF-40® cross-linking agent) using a brush;
drying for 5 minutes at 70° C. in a ventilated oven.

Peeling Tests

Adhesion of the substrates is directly linked to the values for the peeling forces.

A peeling test in accordance with International standard ISO 11339 was carried out on the laminates of each of tests Nos 1 to 27 at a speed of 100 mm/minute. The peeling tests were preferably carried out during a period in the range 2 hours to 48 hours after bonding.

The results of the various tests are shown in Tables 1 to 4.

The results show that irrespective of the hardness of the Pebax® used, high peeling resistances of well over 3 kg/cm were obtained because of the method for manufacturing the laminates of the invention. The adhesion results were optimized with peeling forces of more than 8, especially for laminates wherein the two substrates were (TPE-PA) based, and for activation temperatures (curing) of the order of 90° C. or 100° C. for even better adhesion.

Using an adhesion promoter in the adhesive joint of the invention does not necessitate a specific prior step for evaporating water. The two substrates may be brought into contact directly after rapid thermal activation (approximately 5 minutes) of the layer of the adhesive joint applied to at least one of the substrates. Contacting is carried out in a press at ambient temperature.

Table 1 shows the peeling force results for various tests carried out on Pebax® 5533 substrates and on Pebax® 7033 substrates with primers with no adhesion promoter (ARF 40) or with an adhesion promoter (Dispercoll BL XP 2514) for activation temperatures (curing) of the primer of 90° C. or 100° C.

Examples Nos: 10, 14 and 18, 22 in accordance with the invention exhibited regular adhesion and a degree of adhesion that was higher than that of the corresponding comparative tests (tests Nos: 2, 3 and 5, 6 respectively) which did not use the adhesion promoter of the present invention in the primer.

The adhesion results were further improved with activation temperatures of 100° C.

Comparison of the examples of the invention No: 10 of Table 1 and No: 11 of Table 2:

On amorphous Pebax/Pebax substrates, the adhesion efficiency of the adhesion promoter in the primer was decoupled because of the presence of amorphous PEBA. Note in this regard the synergistic effect of the adhesion promoter in the adhesive joint of the present invention and of the adhesion promoter (amorphous PEBA) in the PEBA material, as defined in French patent application No: 07/58478.

The greater the weight ratio of the amorphous PEBA (5%, 10%, 15%) in the PEBA substrate, the greater the adhesion efficacy (peeling force more than 7 kg/cm).

The examples of the invention Nos: 12, 13, 26 and 27 of Table 2 exhibit a peeling force of more than 6 or 7 kg/cm, irrespective of the mode of incorporation of the adhesion promoter of the invention: either into the primer or into the adhesive (with no prior primer layer) in these examples.

Tables 3 and 4 demonstrate that an increase in the activation temperature (100° C. instead of 90° C.) caused an increase in the degree of adhesion (peeling forces of more than 8 or 10 kg/cm in all cases).

Table 4 shows that, compared with adhesion on a pure Pebax® 7033 substrate (Examples 18 and 22), the degree of adhesion with an adhesion promoter of the invention on a Pebax® 7033/amorphous PEBA substrate is multiplied due to the synergistic effect of the “amorphous PEBA” promoter (A) as defined in French patent application No: 07/58478 and the promoter (P) of the invention.

TABLE 1

| | | | | | | | | | | | | Peeling | |
|---|---|---|---|---|---|---|---|---|---|---|---|---|---|
| | | | | | | Primer | | | | | | test | |
| | | | | | | curing | | | | | | Peeling | |
| | | | | Primer II | | temper- | | | | | | Force | |
| No | Support S1 | Cleaning | Primer I | ARF40% | BL XP | ature | Adhesive | Adhesive | Primer | Cleaning | Support S2 | Kg/cm | Remarks |
| 1 | Pebax ® | MEK | Aquace | 5% | — | 70° C. | Aquace | Aquace | DPLY | MEK | Pebax ® | 0.5 to 1.0 | Irregular |
| | 5533 | | W104 | | | | W01 | W01 | 171-2 | | 5533 | | adhesion |
| 2 | Pebax ® | MEK | Aquace | 5% | — | 90° C. | Aquace | Aquace | DPLY | MEK | Pebax ® | 0.5 to 1.0 | Irregular |
| | 5533 | | W104 | | | | W01 | W01 | 171-2 | | 5533 | | adhesion |
| 3 | Pebax ® | MEK | Aquace | 5% | — | 100° C. | Aquace | Aquace | DPLY | MEK | Pebax ® | 0.5 to 1.0 | Irregular |
| | 5533 | | W104 | | | | W01 | W01 | 171-2 | | 5533 | | adhesion |
| 10 | Pebax ® | MEK | Aquace | — | 5% | 90° C. | Aquace | Aquace | DPLY | MEK | Pebax ® | >5.0 | Regular |
| | 5533 | | W104 | | | | W01 | W01 | 171-2 | | 5533 | | adhesion |
| 14 | Pebax ® | MEK | Aquace | — | 5% | 100° C. | Aquace | Aquace | DPLY | MEK | Pebax ® | >8.0 | Regular |
| | 5533 | | W104 | | | | W01 | W01 | 171-2 | | 5533 | | adhesion |
| 4 | Pebax ® | MEK | Aquace | 5% | — | 70° C. | Aquace | Aquace | DPLY | MEK | Pebax ® | 0.5 to 1.0 | Irregular |
| | 7033 | | W104 | | | | W01 | W01 | 171-2 | | 5533 | | adhesion |
| 5 | Pebax ® | MEK | Aquace | 5% | — | 90° C. | Aquace | Aquace | DPLY | MEK | Pebax ® | 0.5 to 1.0 | Irregular |
| | 7033 | | W104 | | | | W01 | W01 | 171-2 | | 5533 | | adhesion |
| 6 | Pebax ® | MEK | Aquace | 5% | — | 100° C. | Aquace | Aquace | DPLY | MEK | Pebax ® | 0.5 to 1.0 | Irregular |
| | 7033 | | W104 | | | | W01 | W01 | 171-2 | | 5533 | | adhesion |
| 18 | Pebax ® | MEK | Aquace | — | 5% | 90° C. | Aquace | Aquace | DPLY | MEK | Pebax ® | >4.0 | Regular |
| | 7033 | | W104 | | | | W01 | W01 | 171-2 | | 5533 | | adhesion |
| 22 | Pebax ® | MEK | Aquace | — | 5% | 100° C. | Aquace | Aquace | DPLY | MEK | Pebax ® | >4.0 | Regular |
| | 7033 | | W104 | | | | W01 | W01 | 171-2 | | 5533 | | adhesion |

TABLE 2

| | | | | | | | | | | | | Peeling | |
|---|---|---|---|---|---|---|---|---|---|---|---|---|---|
| | | | | | | Primer | | | | | | test | |
| | | | | Primer II | | curing | | | | | | Peeling | |
| | | | | | Dispercoll | temper- | | | | | | Force | |
| No | Support S1 | Cleaning | Primer I | ARF40% | [symbol] | ature | Adhesive | Adhesive | Primer | Cleaning | Support S2 | Kg/cm | Remarks |
| 7 | Pebax ® | MEK | Aquace | 5% | — | 90° C. | Aquace | Aquace | DPLY | MEK | Pebax ® | >5.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 95/5 | | | | | | | | | | | | |
| 11 | Pebax ® | MEK | Aquace | — | 5% | 90° C. | Aquace | Aquace | DPLY | MEK | Pebax ® | >6.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 95/5 | | | | | | | | | | | | |
| 12 | Pebax ® | MEK | Aquace | — | 5% | 90° C. | Aquace | Aquace | DPLY | MEK | Pebax ® | >7.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 90/10 | | | | | | | | | | | | |
| 26 | Pebax ® | MEK | — | — | — | — | Aquace | Aquace | DPLY | MEK | Pebax ® | >6.0 | Regular |
| | 5533/ | | | | | | W01 + | W01 | 171-2 | | 5533 | | adhesion |
| | amorphous | | | | | | 5%* | | | | | | |
| | Pebax | | | | | | dispercoll | | | | | | |
| | ratio 90/10 | | | | | | BLXP | | | | | | |
| | | | | | | | 2514 | | | | | | |
| 13 | Pebax ® | MEK | Aquace | — | 5% | 90° C. | Aquace | Aquace | DPLY | MEK | Pebax ® | >7.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 85/15 | | | | | | | | | | | | |
| 27 | Pebax ® | MEK | — | — | — | — | Aquace | Aquace | DPLY | MEK | Pebax ® | >7.0 | Regular |
| | 5533/ | | | | | | W01 + | W01 | 171-2 | | 5533 | | adhesion |
| | amorphous | | | | | | 5%* | | | | | | |
| | Pebax | | | | | | dispercoll | | | | | | |
| | ratio 85/15 | | | | | | BLXP | | | | | | |
| | | | | | | | 2514 | | | | | | |

[symbol]

indicates data missing or illegible when filed

TABLE 3

| | | | | | | | | | | | | Peeling | |
|---|---|---|---|---|---|---|---|---|---|---|---|---|---|
| | | | | | | Primer | | | | | | test | |
| | | | | Primer II | | curing | | | | | | Peeling | |
| | | | | | Dispercoll | temper- | | | | | | Force | |
| No | Support S1 | Cleaning | Primer I | ARF40% | [symbol] | ature | Adhesive | Adhesive | Primer | Cleaning | Support S2 | Kg/cm | Remarks |
| 15 | Pebax ® | MEK | Aquace | — | 5% | 100° C. | Aquace | Aquace | DPLY | MEK | Pebax ® | >10.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 95/5 | | | | | | | | | | | | |
| 16 | Pebax ® | MEK | Aquace | — | 5% | 100° C. | Aquace | Aquace | DPLY | MEK | Pebax ® | >10.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 90/10 | | | | | | | | | | | | |
| 17 | Pebax ® | MEK | Aquace | — | 5% | 100° C. | Aquace | Aquace | DPLY | MEK | Pebax ® | >10.0 | Regular |
| | 5533/ | | W104 | | | | W01 | W01 | 171-2 | | 5533 | | adhesion |
| | amorphous | | | | | | | | | | | | |
| | Pebax | | | | | | | | | | | | |
| | ratio 85/15 | | | | | | | | | | | | |

[symbol]

indicates data missing or illegible when filed

TABLE 4

| | | | | | | | | | | | | Peeling | |
|---|---|---|---|---|---|---|---|---|---|---|---|---|---|
| | | | | | | Primer | | | | | | test | |
| | | | | Primer II | | curing | | | | | | Peeling | |
| | | | | | Dispercoll | temper- | | | | | | Force | |
| No | Support S1 | Cleaning | Primer I | ARF40% | [symbol] | ature | Adhesive | Adhesive | Primer | Cleaning | Support S2 | Kg/cm | Remarks |
| 19 | Pebax ® | MEK | Aquace | — | 5% | 90° C. | Aquace | Aquace | DPLY | MEK | Pebax ® | >5.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 95/5 | | | | | | | | | | | | |
| 23 | Pebax ® | MEK | Aquace | — | 5% | 100° C. | Aquace | Aquace | DPLY | MEK | Pebax ® | >8.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 95/5 | | | | | | | | | | | | |
| 20 | Pebax ® | MEK | Aquace | — | 5% | 90° C. | Aquace | Aquace | DPLY | MEK | Pebax ® | >6.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 90/10 | | | | | | | | | | | | |
| 24 | Pebax ® | MEK | Aquace | — | 5% | 100° C. | Aquace | Aquace | DPLY | MEK | Pebax ® | >8.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 90/10 | | | | | | | | | | | | |
| 21 | Pebax ® | MEK | Aquace | — | 5% | 90° C. | Aquace | Aquace | DPLY | MEK | Pebax ® | >7.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 85/15 | | | | | | | | | | | | |
| 25 | Pebax ® | MEK | Aquace | — | 5% | 100° C. | Aquace | Aquace | DPLY | MEK | Pebax ® | >10.0 | Regular |
| | 7033/ | | W104 | | | | W01 | W01 | 171-2 | | 5533 | | adhesion |
| | amorphous | | | | | | | | | | | | |
| | Pebax | | | | | | | | | | | | |
| | ratio 85/15 | | | | | | | | | | | | |

[symbol]

indicates data missing or illegible when filed

1. A laminated product comprising an encapsulated adhesion promoter (P) in an effective quantity in an aqueous adhesive joint, said aqueous adhesive joint bonding a surface of a first substrate (S1) to a surface of a second substrate (S2), at least one of said two substrates comprising a material (TPE-PA) comprising at least one thermoplastic elastomer (TPE) and/or at least one polyamide (PA), said adhesion promoter (P) comprising at least one organic molecule comprising at least two isocyanate functions block by encapsulation of said organic molecule.

2. The laminated product as claimed in claim 1, wherein said aqueous adhesive joint comprises at least one layer of aqueous primer and/or at least one layer of aqueous adhesive, said encapsulated adhesion promoter (P) being used in said aqueous primer and/or said aqueous adhesive such that the quantity of adhesion promoter (P) represents 0.5% to 20% by weight of active substance with respect to the total adhesive joint weight.

3. The laminated product as claimed in claim 2, wherein said adhesive and/or said primer are in the bicomponent form:
a first component comprising a functionalized or non-functionalized resin, in solution or in dispersion in water, and reactive with the isocyanate functions;
a second component comprising a cross-linking agent in solution or in dispersion in water, said cross-linking agent comprising at least one molecule having blocked or non-blocked aliphatic isocyanate group(s) and/or at least said encapsulated adhesion promoter (P).

4. The laminated product as claimed in claim 3, wherein said first component and said second component are included in a ready-to-use monocomponent adhesive and/or primer composition.

5. The laminated product as claimed in claim 1, wherein said encapsulated adhesion promoter (P) comprises at least one aromatic organic molecules having isocyanate groups selected from the group consisting of: 4,4′-methylene di(phenylisocyanate) (MDI), isophorone diisocyanate (IPDI), toluylene diisocyanate (TDI), toluylene diisocyanate-uretdione (TDI-U), TDI-urea, naphthalene-1,5-diisocyanate (NDI), 3,3′-dimethyl biphenyl-4,4′-diisocyanate (TODI) and IPDI isocyanurate (IPDI-T), and mixtures thereof.

6. The laminated product as claimed in claim 1, wherein said encapsulated adhesion promoter comprises at least one TDI type and/or IPDI type aromatic isocyanate.

7. The laminated product as claimed in claim 1, wherein said encapsulation comprises at least one encapsulating agent selected from aliphatic amines and mixtures thereof.

8. The laminated product as claimed in claim 7, wherein said at least one encapsulating agent is selected from the group consisting of: 2-pentamethylene-1,5-diamine and its isomers and homologs; 1,6-hexamethylene diamine, di-sec-butylamine; ethylene diamine; 1,3-propylene diamine; diethylene triamine; triethylene tetramine; 3,3′-dimethyl-4,4′-diaminodicyclohexylmethane; methylnonane diamine; isophorone diamine; 4,4′-diaminodicyclohexylmethane; an alkanol amine; an alkanol diamine, ethanolamine, and diethanolamine.

9. The laminated product as claimed in claim 1, wherein said at least one TPE is selected from copolyetheresters (COPEs) and/or thermoplastic polyurethanes (TPUs) and/or copolymers having polyamide blocks and polyether blocks (PEBAs) and/or mixtures thereof.

10. The laminated product as claimed in claim 1, wherein the material of substrate S1 and the material of substrate S2 have the same chemical nature.

11. The laminated product as claimed in claim 1, wherein the material of substrate S1 and the material of substrate S2 have different natures, S2 being selected from the group consisting of TPEs, homopolymers and copolymers; polyolefins; polyamines; polyamides; polyesters; polyethers; polyesterethers; polyimides; polycarbonates; phenolic resins; polyurethanes, cross-linked or not cross-linked; poly(ethylene-vinyl acetate); natural or synthetic elastomers; polybutadienes, polyisoprenes, styrene-butadiene-styrenes (SBS), styrene-butadiene-aerylonitriles (SBN), polyacrylonitriles; natural or synthetic fabrics; fabrics formed from polypropylene, polyethylene, polyesters, polyvinyl alcohol, polyvinyl acetate, polyvinyl chloride or polyamide fibers; fabrics formed from glass fibers or carbon fibers, leather, paper or card; and mixtures thereof.

12. A method for assembling two substrates S1 and S2 by bonding by means of an aqueous adhesive joint, at least one of said substrates being formed from (TPE-PA) material comprising at least one thermoplastic elastomer (TPE), and/or at least one polyamide (PA), said method comprising the following order of steps:
(a) cleaning the surface of the (TPE-PA) substrate or substrates with a cleaning solution;
(b) applying an aqueous adhesive joint comprising an adhesion promoter comprising at least one organic molecule comprising at least two isocyanate functions block by encapsulation of said organic molecule to said surface of at least one of the two substrates;
(c) curing the adhesive joint at a temperature in the range 60° C. to 150° C.;
(d) bringing said surface comprising the aqueous adhesive joint of one of the substrates into contact with a surface of the other substrate to form an assembly comprising the two substrates with the aqueous adhesive joint between them;
(e) placing the assembly in a press;
(f) removing the assembly from the press in the form of a laminated product.

13. The method as claimed in claim 12, wherein step (b) for applying said adhesive joint comprises:
applying a layer of primer comprising an adhesion promoter P based on an encapsulated highly reactive aromatic isocyanate;
applying a layer of bicomponent adhesive based on a low reactivity non-blocked aliphatic isocyanate.

14. (canceled)

15. An aqueous adhesion promoting adhesive joint for bonding a surface of a first substrate (S1) to a surface of a second substrate (S2), at least one of said substrates comprising a material (TPE-PA) comprising at least one thermoplastic elastomer (TPE) and/or at least one polyamide (PA), said adhesive joint comprising an encapsulated adhesion promoter as defined in any one of claims 1 to 11.

16. The laminated product as claimed in claim 1, wherein said at least one TPE/PA substrate comprises at least one material formed from amorphous or quasi-amorphous TPE and/or amorphous or quasi-amorphous polyamide.

17. The laminated product as claimed in claim 16, wherein said material has an amorphous or quasi-amorphous TPE and/or amorphous or quasi-amorphous polyamide content representing 5% to 70% by weight of the total material weight.

18. The laminated product as claimed in claim 16, wherein said at least one amorphous or quasi-amorphous TPE is selected from: amorphous or quasi-amorphous COPEs and/or amorphous or quasi-amorphous TPUs and/or amorphous or quasi-amorphous PEBAs.

19. The laminated product as claimed in claim 2, wherein said encapsulated adhesion promoter (P) is used in said aqueous primer and/or said aqueous adhesive such that the quantity of adhesion promoter (P) represents 0.5% to 10% by weight of active substance with respect to the total adhesive joint weight.
